(19) United States
(12) Patent Application Publication
(10) Pub. No.: US 2007/0046013 A1
(43) Pub. Date: Mar. 1, 2007

(54) Steering system

(75) Inventor: Kazuaki Bito, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/505,368

(22) Filed: Aug. 17, 2006

(30) Foreign Application Priority Data
Aug. 30, 2005 (JP) 2005-248813

(51) Int. Cl. B62D 1/00; B60R 21/203

(52) U.S. Cl. 280/777; 280/731

(57) ABSTRACT

A steering wheel is securely mounted on a bracket which is fixed to a reinforcement of a vehicle via a rod which extends along a longitudinal direction of the vehicle in such a manner as to move relatively thereto. A bellows-like member is interposed between a seat portion of the rod and the bracket, so that the bellows-like member is contractible along the longitudinal direction of the vehicle when a predetermined magnitude of impact is applied to the steering wheel from a rear side of the vehicle by an occupant who is caused to move forwards in association with the application of an external force from the front of the vehicle due to the vehicle being involved in a frontal collision or the like, whereby the impact so applied to the steering wheel is absorbed by the bellows-like member.

### BACKGROUND OF THE INVENTION

1. Field of the Invention

The present invention relates to a steering system of a vehicle, and more particularly to a steering system including an impact absorbing device for absorbing an impact applied to a steering wheel from a rear side of the vehicle.

2. Related Art

As one of conventional steering systems of this type, there has been known a steering system in which an impact absorbing device made up of, for example, a bellows-like member is provided at an intermediate position along the length of a column shaft which is disposed in an inclined fashion between a steering wheel and a fixed portion to a vehicle side so as to connect turning road wheels to the steering wheel of a vehicle in such a manner as to transmit a steering effort from the steering wheel to the turning road wheels. In the steering system like this, when an external force is applied to the vehicle from the front thereof as when the vehicle is involved in a frontal collision, the bellows-like member is deformed to contract by an impact applied to the steering wheel from a rear side of the vehicle by an occupant of the vehicle whose body is being caused to move forwards by virtue of a reaction to the external force so applied. Then, the impact applied to the steering wheel by the occupant is absorbed by virtue of the contracting deformation of the bellows-like member, so as to realize the protection of the occupant (refer to Japanese Patent Publication No. JP-A-9-254793).

Incidentally, when an external force is applied to a vehicle from the front thereof as a result of a frontal collision of the vehicle, an occupant of the vehicle is caused to move substantially horizontally towards the front of the vehicle while applying an impact to a steering wheel towards the front of the vehicle during his or her forward movement, and a bellows-like member functioning as an impact absorbing device receives the impact energy to thereby be contracted.

With respect to this point, in the steering system of the conventional configuration, since the bellows-like member is disposed on an axis of the column shaft which is disposed in the inclined fashion and is caused to contract in an axial direction of the column shaft, a direction in which the applied impact is absorbed follows the axial direction of the column shaft.

Due to this, in the steering system of the conventional configuration, there occurs a case where the direction in which the impact is applied to the steering wheel by the occupant deviates from the direction in which the impact is absorbed by the bellows-like member, and hence, there still remains a room to be improved with respect to an increase in impact absorbing efficiency by the impact absorbing device. In addition, in the steering system of the conventional configuration in which the bellows-like member is disposed in the inclined fashion, in order to absorb the impact sufficiently by the bellows-like member so disposed, the length over which the bellows-like member contracts needs to be increased compared to the moving distance of the occupant. Consequently, since the bellows-like member is increased in size within a limited layout space, there still remains a room to be improved with respect to an increase in the degree of freedom in the layout of the impact absorbing device.

### SUMMARY OF THE INVENTION

The invention was made in the light of the aforesaid problems which are inherent in the related art, and an object thereof is to provide a steering system which can absorb an impact applied to the steering wheel from the rear side of the vehicle with good efficiency while realizing a reduction in size of the configuration of the system.

With a view to accomplishing the object, according to the gist of a first aspect of the invention, there is provided a steering system including a steering wheel supported on a fixed portion to a vehicle side via a steering wheel supporting mechanism and an impact absorbing device interposed between the steering wheel and a rigid portion on the vehicle side for absorbing an impact applied to the steering wheel from a rear side of a vehicle, wherein the impact absorbing device is contractible along the longitudinal direction of the vehicle between the steering wheel and the rigid portion on the vehicle side so as to absorb an impact applied to the steering wheel from the rear side of the vehicle.

According to the aforesaid configuration, the direction in which the impact is applied to the steering wheel and the direction in which the impact is absorbed by the impact absorbing device can be made to coincide with each other, thereby making it possible to absorb the impact with good efficiency. Due to this, an impact absorbing stroke of the impact absorbing device can be shortened, thereby making it possible to realize the reduction in size of the impact absorbing device.

According to the gist of a second aspect of the invention, there is provided a steering system according to the first aspect of the invention, having a facing state adjusting device for changing a facing state of at least part of the steering wheel relative to an occupant of the vehicle when an impact is applied to the steering wheel.

According to the aforesaid configuration, in the steering wheel, by properly adjusting the facing state of at least part thereof can be properly adjusted relative to the occupant, the area of the steering wheel over which the entering occupant is received can be increased, thereby making it possible to increase the protection performance for the occupant.

According to the gist of a third aspect of the invention, there is provided a steering system according to the second aspect of the invention, wherein the impact absorbing device is contractible along the longitudinal direction of the vehicle so as to absorb an impact applied to the steering wheel after the facing state adjusting device has changed the facing state of at least part of the steering wheel relative to the occupant of the vehicle.

According to the aforesaid configuration, the impact applied to the steering wheel can be absorbed after the area of the steering wheel over which the occupant is received has been increased, thereby making it possible to enhance the protection performance for the occupant.

According to the gist of fourth aspect of the invention, there is provided a steering system according to the second aspect of the invention, wherein the impact absorbing device is contractible along the longitudinal direction of the vehicle so as to absorb an impact applied to the steering wheel at the same time as the facing state adjusting device changes the facing state of at least part of the steering wheel relative to the occupant of the vehicle.

According to the aforesaid configuration, the impact applied to the steering wheel can be absorbed while the area of the steering wheel over which the occupant is received is being increased, thereby making it possible to absorb the impact more quickly.

According the gist of a fifth aspect of the invention, there is provided a steering system according to the third or fourth aspect of the invention, wherein of mechanism members which make up the steering wheel supporting mechanism, those which are situated between the steering wheel and the impact absorbing device have a predetermined rigidity which keeps the mechanism members from being deformed by an impact applied to the steering wheel from the rear side of the vehicle, whereby the mechanism members move along the longitudinal direction of the vehicle with respective shapes of the mechanism members held when the impact absorbing device contracts along the longitudinal direction of the vehicle.

According to the aforesaid configuration, since the facing state of the steering wheel relative to the occupant that has been adjusted by the facing state adjusting device is held as adjusted at the time of impact absorbing, the protection performance of the occupant can be maintained high.

According the gist of a sixth aspect of the invention, there is provided a steering system according to any of the first to fifth aspects of the invention, having an operating state detecting device for detecting an operating state of the steering wheel and a control unit for determining on a turning state of the vehicle based on the results of a detection by the operating state detecting device.

There exists no column shaft in a steer-by-wire type steering system. The invention can particularly preferably be adopted for the steer-by-wire type steering system, as well. In addition, in the steer-by-wire type steering system, the degree of freedom in the layout of the impact absorbing device can be increased by such an extent that the column shaft does not exist.

According to the invention, it is possible to provide the steering system which can absorb an impact applied to the steering wheel from the rear side of the vehicle with good efficiency while realizing a reduction in size of the configuration of the system.

### BRIEF DESCRIPTION OF THE DRAWINGS

FIG. 1A is a schematic view which shows the configuration of a steering system of a first embodiment of the invention when it is in a normal state, and FIG. 1B is a schematic view which shows the configuration of the same steering system in such a state that an impact is applied to a steering wheel from a rear side of a vehicle.

FIG. 2 is a schematic view which shows the configuration of the steering system of the first embodiment.

FIG. 3 is a back view of the steering wheel of the first embodiment.

FIG. 4 is a sectional view taken along the line IV-IV in FIG. 3.

FIG. 5A is a partial plan view which shows a steering wheel of a second embodiment, and FIG. 5B is a sectional view taken along the line VB-VB in FIG. 5A.

FIG. 6 is a schematic view which shows the configuration of a steering system of the second embodiment in such a state that an impact is applied to the steering wheel from a rear side of the vehicle.

FIG. 7 is a schematic view which shows the configuration of a steering system of a third embodiment when it is in a normal state.

FIG. 8 is a schematic view which shows the configuration of a steering system of a fourth embodiment when it is in a normal state.

### DETAILED DESCRIPTION OF THE PREFERRED EMBODIMENTS

### First Embodiment

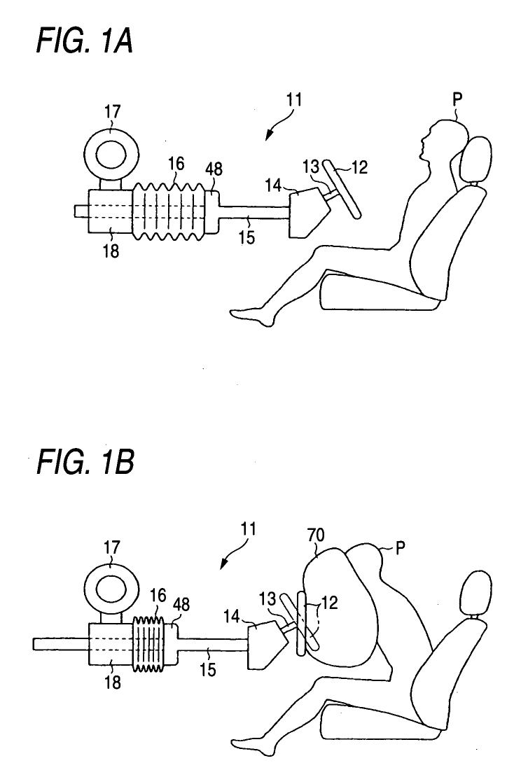

Hereinafter, a first embodiment in which the invention is embodied into a steering system of a vehicle will be described in detail based on FIGS. 1A to 4.

As shown in FIG. 1A, a steering system 11 is made up of a steering wheel 12, a steering shaft 13, a steering unit 14, a rod 15, a bellows-like member 16 which functions as an impact absorbing device and a bracket 18, functioning as fixed portion and a rigid portion, which is supported on a reinforcement 17 which makes up part of a vehicle. In addition, in this embodiment, the steering shaft 13, the steering unit 14 and the rod 15 correspond to mechanism members which make up a steering wheel supporting mechanism.

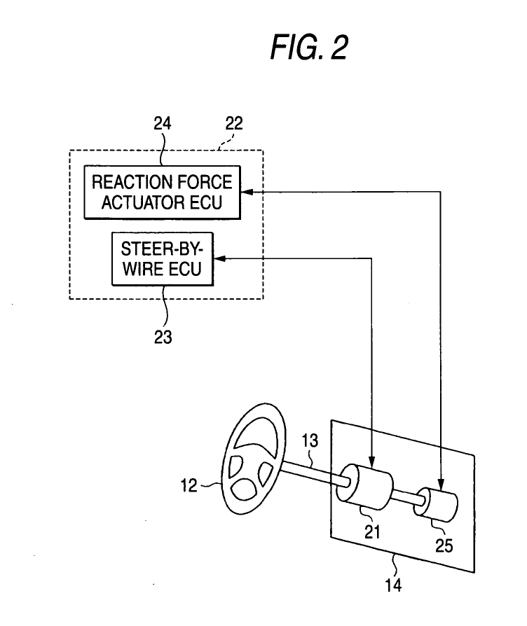

As shown in FIG. 2, the steering unit 14 adopts a steer-by-wire system and includes a rotational angle sensor 21 which functions as an operating state detecting device for detecting the rotational angle of the steering wheel 12 via the steering shaft 13. The rotational angle sensor 21 is communicably connected to a steer-by-wire ECU (a steer-by-wire electronic control unit) 23 disposed in a steer-by-wire control unit 22 which functions as a control unit.

The steer-by-wire ECU 23 includes as its main constituent component a microcomputer which is made up of a CPU, a ROM, a RAM, a timer, an interface and the like. The steer-by-wire ECU 23 determines on a turning angle according to a detection signal of the rotational angle sensor 21 and controls the operation of a turning actuator, not shown, which turns turning road wheels of the vehicle (for example, front wheels of the vehicle), not shown, a predetermined amount.

In addition, a reaction force actuator ECU (a reaction force actuator electronic control unit) 24 is equipped in the steer-by-wire control unit 22. This reaction force actuator ECU 24 includes as its main constituent component a microcomputer which is made up of a CPU, a ROM, a RAM, a timer, an interface and the like and is connected to an reaction force actuator 25 equipped in the steering unit 14. In addition, the reaction force actuator ECU 24 controls the operation of the reaction force actuator 25 so as to generated a predetermined reaction force relative to a turning operation of the steering wheel 12.

Here, since the steering unit 14 adopts the steer-by-wire system, the steering wheel 12 and the turning wheels are not mechanically connected together via a mechanism such as a rack-and-pinion mechanism. Due to this, the reaction force actuator ECU 24 controls the operation of the reaction force actuator 25 in such a manner that a virtual reaction force is generated in the steering wheel 12 via the steering shaft 13.

Next, the steering wheel 12 will be described in detail.

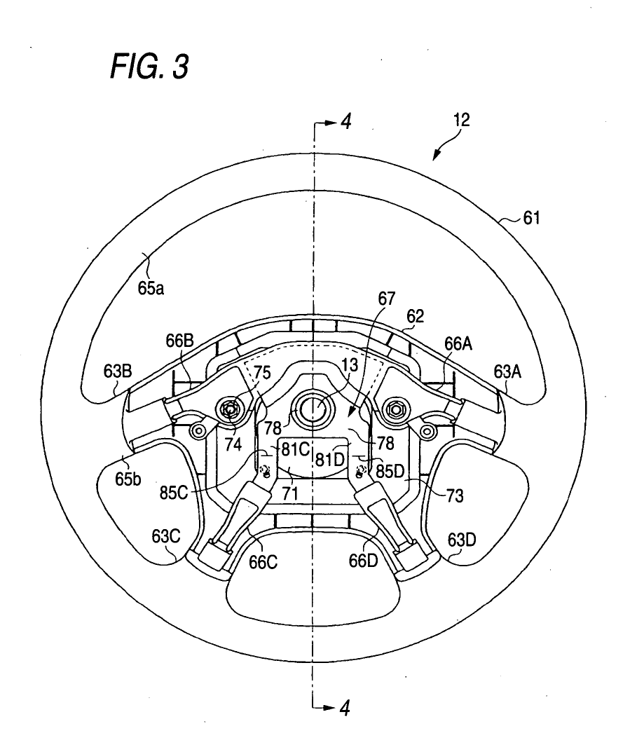

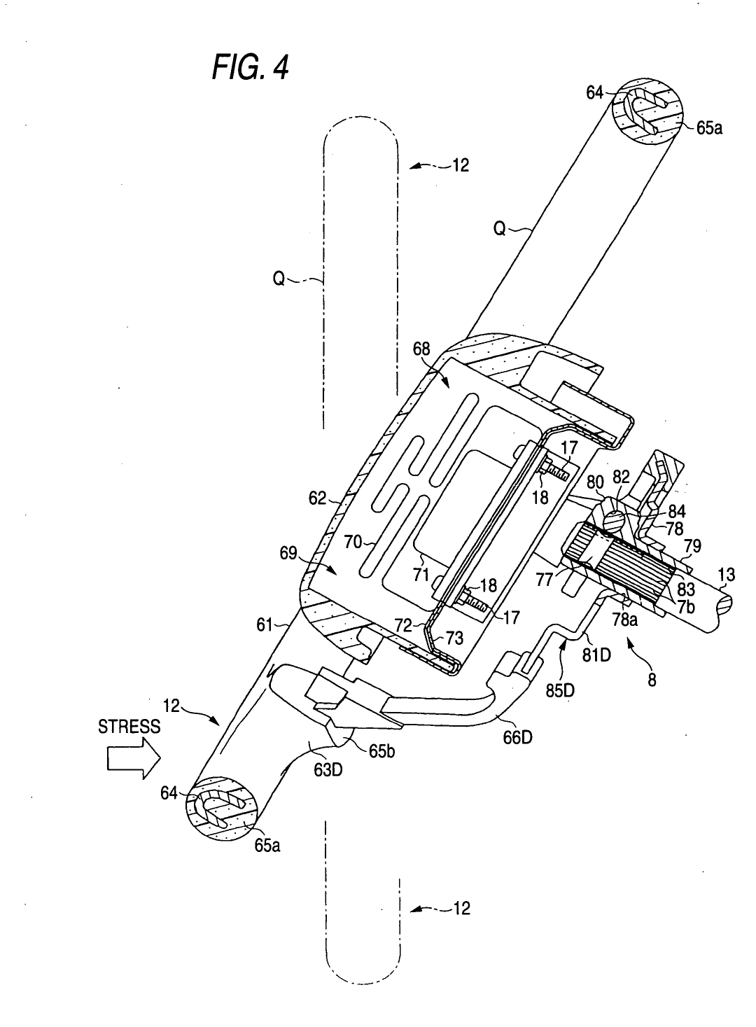

As shown in FIGS. 3 and 4, the steering wheel 12 of the embodiment includes an annular rim portion 61, a pad portion 62 which is disposed at the center of the rim portion 61 and is made mainly up of a soft synthetic resin material (for example, foamed polyurethane), and four spoke portions 63A, 63B, 63C, 63D which extends from the rim portion 61. In addition, the rim portion 61 is made up of a rim portion core metal 64 which is made of, for example, a steel pipe and a covering element 65a which covers the rim portion core metal 64, and the spoke portions 63A to 63D are made up of spoke portion core metals 66A, 66B, 66C, 66D, respectively, and a covering element 65b which covers the spoke portion core metals 66A to 66D.

The rim portion core metal 64 and the spoke portion core metals 66A to 66D are diecast molded integrally of magnesium alloy. In addition, the covering elements 65a, 65b are formed of a similar soft synthetic resin material to the pad portion 62. The steering wheel 12 is fixed to a boss portion 67 which is connected to the steering shaft 13 and is made up as an assembly as a whole.

An accommodation space 68 surrounded by the covering element 65b is formed underneath the pad portion 62, and an airbag system 69 is provided in the accommodation space 68. The airbag system 69 is made up of a bag-like airbag 70 which is folded for accommodation, an inflator 71 for supplying an inflation gas to the airbag 70, a ring retainer 72 and a bag holder 73 for holding to fix the airbag 70, the inflator 71 and the ring retainer 72. The bag holder 73 is, as shown in FIG. 3, for example, fixed to the spoke portion core metals 66A, 66B and the like by means of nuts 74 and bolt 75.

Next, a mounting construction of the steering wheel 12 will be described in detail.

As shown in FIGS. 3 and 4, a serrated surface 76 having a predetermined number (generally, about 30) of teeth is formed at a most distal end portion of the steering shaft 13, and an annular groove 77 is formed at a vertically central portion of the serrated surface 76. In addition, the boss portion 67 includes a plate-shaped boss plate 78, a steel cylindrical portion 79 which is welded to be fixed to an inner circumference of a through hole 78a formed in a central portion of the boss plate 78, a yoke portion 80 which is formed into a C-like shape as viewed from the top at an upper portion of the cylindrical portion 79 and connecting portions 81C, 81D which are formed integrally in such a manner as to extend from the boss plate 78 towards the spoke portion core metals 66C, 66D, respectively. In addition, the individual members (the boss plate 78 and connecting portions 81C, 81D and the like) which make up the boss portion 67 are made from a material whose main constituent is iron.

The C-like shaped yoke portion 80 protrudes further upwards then proximal ends of the connecting portions 81C, 81D, that is, the boss plate 78, and bolt holes 82 are formed in the yoke portion 80 substantially at distal end portions of the C-like shape, respectively. In addition, an internal thread is formed in one of the hold holes 82. A serrated surface 83 is formed on an inner circumferential surface of the cylindrical portion 70 in such a manner as to correspond to the serrated surface 76 of the steering shaft 13. Then, the cylindrical portion 79 of the boss portion 67 is fitted on the distal end of the steering shaft 13 through meshing of the serrated surfaces 76, 83 with each other.

Furthermore, bolts 84 are passed through the holt holes 82 in the yoke portion 80, and in particular, a bolt 84 is securely screwed into the bolt hole 82 having the internal thread, whereby the serrated surfaces 76, 83 are made to strongly mesh with each other, and the yoke portion 80 is fastened. Due to this, the relative rotation of the steering wheel 12 to the steering shaft 13 is restricted. In addition, in association with this, a shank portion of the bolt 84 is fitted in the annular groove 77. Due to this, a vertical movement (an axial direction of the steering shaft 13) of the steering wheel 12 is also restricted. In addition, an edge portion of the boss plate 78 which faces the front of the vehicle and end edges of the connecting portions 81C, 81D are embedded in the spoke portion core metals 66A to 66D, and the boss portion 67 and the spoke portion core metals 66A to 66D are connected together through the embedment.

Additionally, as shown in FIGS. 3 and 4, bent portions 85C, 85D which function as facing state adjusting devices, respectively, are provided at intermediate portions of the connecting portions 81C, 81D of the boss portion 67, and these bent portions 85C, 85D make up self-aligning mechanisms, respectively. Namely, as shown in FIG. 4, when an impact (a stress) is imparted to the steering wheel 12 (in particular, the rim portion 61) from the rear of the vehicle by virtue of contact of the body of the occupant P therewith when the vehicle is involved in a frontal collision or the like, the connecting portions 81C, 81D are made to bend about the bent portions 85C, 85D as deformation centers, respectively, so as to change the facing state of the steering wheel 12 relative to the occupant P.

As this occurs, a virtual circular plane Q of the steering wheel 12 that is formed by the annular rim portion 61 thereof rises up from an inclined state where the plane Q intersects the axial direction of the steering shaft 13 at right angles to a perpendicular state where the plane Q follows a vertical direction as indicated by an alternate long and short dash line in FIG. 4, whereby the steering wheel 12 becomes substantially parallel with the body of the occupant P which attempts to move to the front of the vehicle. Then, after its facing state relative to the occupant P has been changed in such a manner that the virtual plane Q of the rim portion 61 becomes substantially parallel with the occupant P, the steering wheel 12 receives the body of the occupant P who attempts to move to the front of the vehicle over the entirety of the virtual plane Q.

In addition, in this embodiment, the bolt holes 82 of the yoke portion 80 are situated further forwards than the center of the rim core metal 64 (that is, the steering shaft 13) in the reference steering state. Due to this, the bolt 84 which is screwed in the yoke portion 80 is provided on a far side of the steering wheel 12 and hence does not exist on a driver side thereof.

Next, a supporting configuration of the steering system 11 relative to the vehicle will be described below.

As shown in FIG. 1A, the steering wheel 12 is connected to the steering shaft 13 via the steering unit 14. The rod 15 is provided in such a manner as to protrude from a side of the steering unit 14 which faces the front of the vehicle. The rod 15 is passed through the bracket 18 fixed to the reinforcement 17 which is provided transversely of the vehicle in such a manner as to move relatively thereto. The rod 15 is disposed so as to be in parallel with a plane where the vehicle is in contact with the ground along the longitudinal direction of the vehicle. A disk-like receiving or seat portion 48 is formed at a central portion of the rod 15, and the bellows-like member 16 is interposed between the seat portion 48 of the rod 15 and the bracket 18. The boss portion 67 of the steering wheel 12, the steering shaft 13, the constituent members of the steering unit 14 and the rod 15 are each formed of a rigid material so as not to be deformed by a predetermined magnitude of impact even though such an impact is applied to the steering wheel from the rear side of the vehicle when the vehicle is involved in a frontal collision.

Next, the function of the steering system 11 of the embodiment will be described.

Firstly, when an impact which exceeds a predetermined value is applied to the vehicle from the front thereof due to the vehicle being involved in a frontal collision or the like, the airbag 70 accommodated within the pad portion 62 is inflated to be deployed as shown in FIG. 1B. The occupant P moves to the front of the vehicle by virtue of the impact imparted from the front of the vehicle and is received by the airbag 70 which has been inflated and deployed.

As this occurs, in the event that the body or the like of the occupant P comes into contact with the rim portion 61 of the steering wheel 12 directly or via the airbag 70, the connecting portions 81C, 81D of the boss portion 67 are deformed about the bent portions 85C, 85D, respectively, by an impact produced when the occupant P enters the airbag 70, whereby the rim portion 61 of the steering wheel 12 is deformed so as to face the entering occupant P substantially square, so that the occupant P is prevented from being brought into intensive contact with part of the rim portion 61, thereby making it possible to realize an effective protection of the occupant P.

After the facing state of the steering wheel 12 relative to the occupant P has been changed in the way described above, the impact imparted to the steering wheel 12 from the rear side of the vehicle is transmitted to the bellows-like member 16 via the steering shaft 13, the steering unit 14 and the rod 15. Then, the rod 15 moves to the front of the vehicle while causing the bellows-like member 16 which is in abutment with the bracket 18 at a front end thereof to contract in such a state that the rod 15 is guided in the longitudinal direction of the vehicle by the bracket 18. Thus, the impact applied to the steering wheel 12 is absorbed by virtue of the contraction of the bellows-like member 16.

Consequently, the following advantages are exhibited by the embodiment.

(1) In this steering system 11, the impact applied to the steering wheel 12 from the rear side of the vehicle by the occupant P is made to be absorbed by the contraction of the bellows-like member 16 along the longitudinal direction of the vehicle. Due to this, the direction in which the impact is applied to the steering wheel 12 by the occupant who is moving forwards in association with the collision of the vehicle can be made to coincide with the direction in which the impact so applied is absorbed by the bellows-like member 16. Consequently, the impact can be absorbed with good efficiency, and the impact absorbing stroke of the bellows-like member 16 can be shortened. Then, the reduction in size of the bellows-like member 16 and hence the steering system 11 can be realized.

(2) In this steering system 11, in the event that an impact is applied to the steering wheel 12, the bent portions 85C, 85D are provided at the connecting portions 81C, 81D of the boss portion 67 which are adapted to change the facing state of the rim portion of the steering wheel 12 relative to the occupant P of the vehicle when subjected to the impact (stress). Then, the circular virtual plane Q that is formed by the annular rim portion 61 is put in the substantially square facing state (the perpendicular state) to the body of the occupant P, so as to receive the occupant P who attempts to move to the front of the vehicle over the entirety of the virtual plane Q. Due to this, in the steering wheel 12, the area over which the entering occupant P is received can be increased, thereby making it possible to enhance the protection performance for the occupant P.

(3) In this steering system 11, the bellows-like member 16 is contractible along the longitudinal direction of the vehicle after the facing state of the steering wheel 12 relative to the occupant P of the vehicle has been changed. Due to this, the impact applied to the steering wheel 12 can be absorbed after the area in the steering wheel 12 over which the occupant P is received has been increased.

(4) In this steering system, the constituent members residing between the boss portion 67 of the steering wheel 12 and the bellows-like member 16 have the predetermined rigidity and are made to move with their respective shapes maintained when an impact is absorbed by the bellows-like member 16. Due to this, when the impact is absorbed by the bellows-like member 16, the facing state of the steering wheel 12 that has been adjusted relative to the occupant P can be held, thereby making it possible to maintain high the protection performance for the occupant P.

(5) The steering system 11 constitutes a steer-by-wire type steering system. Due to this, the degree of freedom in the layout of the bellows-like member 16 can be enhanced by such an extent that there exists a long column shaft.

### Second Embodiment

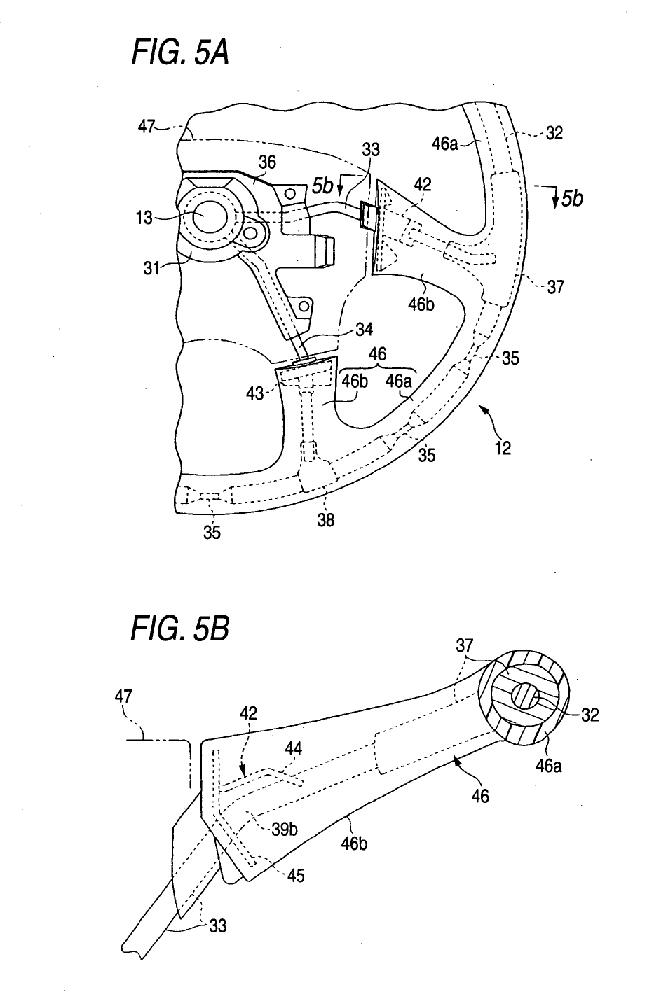

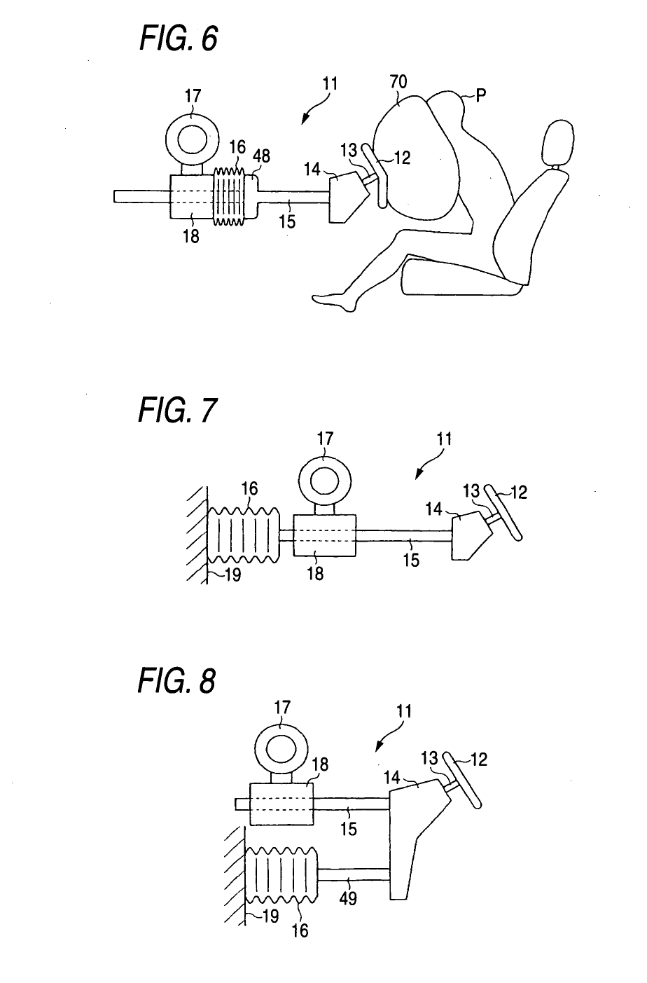

Next, a steering system according to a second embodiment of the invention will be described based on FIGS. 5A, 5B and 6 while focusing on portions thereof which differ from the first embodiment.

In a steering system 11 of the second embodiment, as shown in FIG. 5A, a steering wheel 12 includes a boss portion 31 which is connected to a steering shaft 13, a rim portion 32 which is provided in such a manner as to surround the boss portion 31, first and second spoke core metals 33, 34 which connect the rim portion 32 and the boss portion 31 together, respectively. The rim portion 32 is formed of a round iron rod into an annular shape and has constricted portions 35 which make up part of a facing state adjusting device at predetermined positions thereon which exclude joining regions where the first and second spoke core metals 33, 34 are joined to the rim portion 32, whereby when the vehicle is involved in a frontal collision or the like, the constricted portions 35 are deformed so as to realize the protection of an occupant P.

The first and second spoke core metals 33, 34 are each formed of a round iron rod and are disposed substantially radially so as to connect the boss portion 31 and the rim portion 32 together. A boss portion joining portion 36 is provided at a central portion of the steering wheel 12 which is diecast molded to cover joining regions where inner end portions of the first and second spoke core metals 33, 34 are joined to the boss portion 31. In addition, provided on an outer circumferential portion of the steering wheel 12 are a first rim portion joining portion 37 which is diecast molded to cover the joining region where an outer end portion of the first spoke core metal 33 is joined to the rim portion 32 and a second rim portion joining portion 38 which is diecast molded to cover the joining region where an outer end portion of the second spoke core metal 34 is joined to the rim portion 32.

A first inner curved portion 39a and a first outer curved portion 39b (refer to FIG. 5B), which constitute part of the facing state adjusting device, are provided individually at a longitudinally central portion of the first spoke core metal 33. A second inner curved portion 40a and a second outer curved portion (not shown), which constitute part of the facing state adjusting device, are provided individually at a longitudinally central portion of the second spoke core metal 34. In addition, the first and second inner curved portions 39a, 40a, and the first outer curved portion 39b and the second outer curved portion are each formed by curving the first or second spoke core metal 33, 34. The first and second inner curved portions 39a, 40a, and the first outer curved portion 39b and the second outer curved portion deform in a predetermined deforming mode in cooperation with the constricted portions 35 so as to realize the protection of the occupant P when the body of the occupant P is brought into contact with the rim portion 32 directly or via an airbag 70 (refer to FIG. 6) which is inflated to be deployed when the vehicle is involved in a frontal collision or the like.

The first inner curved portion 39a functions as a deformation center about which the central portion of the first spoke core metal 33 is deformed in such a manner as to swell out to the front of the vehicle, and the second inner curved portion 40a functions as a deformation center about which the central portion of the second spoke core metal 34 is deformed in such a manner as to swell out to the outside of the vehicle. The first outer curved portion 39b functions as a deformation center about which the central portion of the first spoke core metal 33 is deformed in such a manner as to swell out upwards. Similarly, the second outer curved portion functions as a deformation center about which the central portion of the second spoke core metal 34 is deformed in such a manner as to swell out upwards.

As shown in FIG. 5A, first and second insert members 42, 43 are fixedly provided at longitudinally central portions of the first and second spoke core metals 33, 34, respectively, which are formed into a T-shape as viewed from the top and a T-shape as viewed from the side, respectively, by bending iron plates into predetermined shapes. Note that since the second insert member 43 has a similar configuration to that of the second insert member 42, here, only the configuration of the first insert member 42 will be described.

As shown in FIG. 5B, a first insert member 42 includes a support portion 44 which extends rectilinearly along the first spoke core metal 33 and a shape holding portion 45 which is provided in such a manner as to intersect the first spoke core metal 33 substantially at right angles.

A notched portion which is notched into an arc shape is provided at a proximal end portion of the support portion 44. This notched portion is formed in such a manner as to correspond to the shape of an upper end portion of the first spoke core metal 33. This notched portion is welded to the first spoke core metal 33 in such a state as to be locked thereon, so as to secure the first insert member 42 to the first spoke core metal 33. In addition, a central portion and a distal end portion of the support portion 44 are made to extend substantially in parallel with the first spoke core metal 33 above the first spoke core metal 33.

The shape holding portion 45 is provided at a position which substantially faces the first outer curved portion 39b while spaced apart from the first spoke core metal 33 by a predetermined distance in such a state that the shape holding portion 45 surrounds the first spoke core metal 33 from above and both sides thereof. On the other hand, the joining (welding) of the notched portion to the first spoke core metal 33 is implemented on the steering wheel 12 at a further outward position than the first outer curved portion 39b.

As shown in FIG. 5A, the steering wheel 12 includes further a grip portion 46 which covers the whole rim portion 32 and outer end portions of the first and second spoke core metals 33, 34 and a pad portion 47 which covers over the boss portion 31. Note that the grip portion 46 and the pad portion 47 are made up of different members. The pad portion 47 is formed from a synthetic resin into a long quadrangular cylindrical shape and is provided in such a manner as to cover over a driver's seat airbag module (not shown) which is provided on an upper surface of the boss portion joining portion 36 and which accommodates therein the airbag 70 in a folded state.

The grip portion 46 is formed into a substantially annular shape by covering the rim portion 32 and the outer end portions of the first and second core metals 33, 34 with a soft resin and enhances the gripping easiness and anti-slipping performance so as to increase the operability of the steering wheel 12. This grip portion 46 is made up of an annular rim covering portion 46a which covers the perimeter of the rim portion 32 and spoke covering portions 46b which cover the perimeters of the outer end portions of the first and second core metals 33, 34, respectively.

As shown in FIG. 5B, the spoke covering portions 46b are formed on rim sides of the first and second spoke core metals 33, 34 which extend from the boss portion 31 to the rim portion 32, respectively. Namely, the spoke covering portions 46b are formed from the longitudinally central portions to the outer end portions of the first and second spoke core metals 33, 34, respectively. An inner end portion (a boss portion 31 side) of the spoke covering portion 46b is formed in such a manner as to follow the shape holding portion 45 of the first insert member 42.

Also in the steering system 11 of the second embodiment that has been described heretofore, in the event that an impact which exceeds a predetermined value is imparted from the front of the vehicle when the vehicle is involved in a frontal collision or the like, the occupant P is caused to move to the front of the vehicle by the impact as shown in FIG. 6 and is received by the airbag 70 which has been inflated to be deployed. In addition, as this occurs, in the event that the body or the like of the occupant P is brought into contact with the rim covering portion 46a of the steering wheel 12 directly or via the airbag 70 which is inflated to be deployed, the rim portion 32 is deformed about the constricted portions 35 by virtue of an impact produced when the occupant P enters the airbag 70. Furthermore, the first and second spoke core metals 33, 34 are deformed about the first and second inner curbed portions 39a, 40a, and the first outer curved portion 39b and the second outer curved portion.

Here, the first and second inner curved portions 39a, 40a facilitate the deformation of the rim portion 32, which lies further rearwards (closer to the occupant P), towards the front of the vehicle, while the first outer curved portion 39b and the second outer curved portion facilitate the deformation of the rim portion 32 downwards, whereby when a lower portion of the rim portion 32 (part of the steering wheel 12) is deformed so as to face the entering occupant P substantially square, so that the occupant P is prevented from being brought into intensive contact with part of the rim portion 32, thereby making it possible to realize an effective protection of the occupant P.

In addition, after the facing state of part of the steering wheel 12 relative to the occupant P has been changed, as with the first embodiment, the impact applied to the steering wheel 12 from the rear side of the vehicle by the occupant P is transmitted to the bellows-like member 16 via the steering shaft 13, a steering unit 14 and a rod 15. Then, the impact applied to the steering wheel 12 is absorbed by the bellows-like member 16 which is moved to the front of the vehicle while being caused to contract along the longitudinal direction of the vehicle. Consequently, also in this embodiment, the same advantages as those of the first embodiment are exhibited.

### Third Embodiment

Next, a steering system according to a third embodiment of the invention will be described based on FIG. 7 while focusing on portions which differ from the embodiments that have been described before.

As shown in FIG. 7, in a steering system 11 of the third embodiment, a distal end of a rod 15 is supported on a rigid portion (for example, a chassis or the like) 19 via a bellow-like member 16 at a position lying further forwards on the vehicle than a bracket 18 which functions as a fixed portion which supports the rod 15 which passes therethrough along the longitudinal direction of the vehicle.

Consequently, also according to the embodiment, when an impact is applied to a steering wheel 12 from the rear side of the vehicle, since the bellows-like member 16, which is in abutment with the rigid portion 19 of the vehicle at a front end thereof, the same advantages as those of the first embodiment are exhibited.

### Fourth Embodiment

Next, a steering system according to a fourth embodiment of the invention will be described based on FIG. 8 while focusing on portions which differ from the embodiments that have been described above.

In a steering system 11 of the fourth embodiment, as shown in FIG. 8, a rigidly formed connecting rod 49 is provided on a steering unit 14 separately from a rod 15 which is passed through a bracket 18 which functions as a fixed portion fixed to a reinforcement 17 of the vehicle in such a manner as to extend therefrom in parallel with the rod 15. In addition, a distal end of the connecting rod 49 is supported on a rigid portion (for example, a chassis or the like) 19 of the vehicle via a bellow-like member 16.

Consequently, according to this embodiment, in addition to the same advantages as those of the first embodiment, the following advantage is exhibited.

In this steering system 11, since the steering unit 14 is supported on the vehicle via the rod 15 and the connecting rod 49, the supporting state of the steering unit 14 is stabilized further.

Modifications

Note that the individual embodiments of the invention can also be embodied by being modified as below.

In each of the embodiments, the facing state adjusting device (the bent portions 85C, 85D, the constricted portions 35, the first inner curved portion 39a, the first outer curved portion 39b, the second inner curved portion 40a) which makes up the self-aligning mechanism may be configured so as to change the facing state of the steering wheel 12 relative to the occupant P even when the airbag 70 is not deployed.

In each of the embodiments, while the invention is embodied into the steer-by-wire type steering system, the invention can be embodied into a column shaft type steering system in which a column shaft is provided and turning road wheels and a steering wheel 12 are mechanically connected together via the column shaft.

In the steering wheel 12 according to the second embodiment, the second spoke core metal 34 may be omitted.

In the steering wheel 12 according to the second embodiment, the first outer curved portion 39b may be provided in such a manner as to be situated at a further inward position on the steering wheel 12 than the inner end portion of the spoke covering portion 46b. In addition, a curved portion which plays the role of the first outer curved portion 39b may be formed on a radially inward side of the steering wheel 12, while a curved portion which plays the role of the first inner curved portion 39a may be formed on a radially outward side of the steering wheel 12.

In the first spoke core metal 33 of the second embodiment, a configuration may be adopted in which the first outer curved portion 39b is omitted, and only the first inner curved portion 39a is provided.

In the steering wheel 12 of the second embodiment, in place of the first and second inner curved portions 39a, 40a, and the first outer curved portion 39b and the second outer curved portion, other deformable configurations may be adopted. For example, a predetermined location at the central portion of the first or second spoke core metal 33, 34 may be formed thinner like the constricted portions 35 of the rim portion 32. Alternatively, a notch may be provided at the predetermined location.

In the steering systems 11 of the first to fourth embodiments, in place of the bellows-like member 16, a member having a honeycomb construction, for example, which is deformed by an impact, a gas-filled cylinder, a hydraulic cylinder and the like may be adopted. In addition, for example, the rod 15 may have a double-construction made up of a first rod which is provided on the steering unit 14 in such a manner as to protrude therefrom and a second rod which is fixed to the rigid portion of the vehicle, which are locked at predetermined relative positions. Then, when a impact exceeding a predetermined value is applied to the steering wheel 12, the locking of the rods is released, so that both the rods move in the longitudinal direction of the vehicle relatively to each other, whereby the whole rod 15 is contracted. In this case, a damper mechanism is desirably provided for adjusting the relative moving speed of both the rods.

What is claimed is:

1. A steering system comprising:
a steering wheel supported on a fixed portion to a vehicle via a steering wheel supporting mechanism and an impact absorbing device interposed between the steering wheel and a rigid portion on the vehicle for absorbing an impact applied to the steering wheel from a rear side of the vehicle,
wherein the impact absorbing device is contractible along a longitudinal direction of the vehicle between the steering wheel and the rigid portion on the vehicle so as to absorb an impact applied to the steering wheel from the rear side of the vehicle.

2. A steering system according to claim 1, further comprising a facing state adjusting device for changing a facing state of at least part of the steering wheel relative to an occupant of the vehicle when an impact is applied to the steering wheel.

3. A steering system according to claim 2, wherein the impact absorbing device is contractible along the longitudinal direction of the vehicle so as to absorb an impact applied to the steering wheel after the facing state adjusting device has changed the facing state of at least part of the steering wheel relative to the occupant of the vehicle.

4. A steering system according to claim 2, wherein the impact absorbing device is contractible along the longitudinal direction of the vehicle so as to absorb an impact applied to the steering wheel at the same time as the facing state adjusting device changes the facing state of at least part of the steering wheel relative to the occupant of the vehicle.

5. A steering system according to claim 3, wherein of mechanism members which make up the steering wheel supporting mechanism, those which are situated between the steering wheel and the impact absorbing device have a predetermined rigidity which keeps the mechanism members from being deformed by an impact applied to the steering wheel from the rear side of the vehicle, whereby the mechanism members move along the longitudinal direction of the vehicle with respective shapes of the mechanism members held when the impact absorbing device contracts along the longitudinal direction of the vehicle.

6. A steering system according to claim 1, further comprising an operating state detecting device for detecting an operating state of the steering wheel and a control unit for determining on a turning state of the vehicle based on the results of a detection by the operating state detecting device.
